(19) United States
(12) Patent Application Publication
(10) Pub. No.: US 2004/0185277 A1
(43) Pub. Date: Sep. 23, 2004

(54) Stud with enhanced surface

(76) Inventor: Marcio Gerep, Chattanooga, TN (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/778,438

(22) Filed: Feb. 13, 2004

Related U.S. Application Data
(60) Provisional application No. 60/447,456, filed on Feb. 14, 2003.
(60) Provisional application No. 60/447,538, filed on Feb. 14, 2003.

(51) Int. Cl. B32B 15/04

(52) U.S. Cl. 428/469; 428/472; 428/698; 148/530

(57) ABSTRACT

A stud has an exterior in which a diffusion coating is provided on a portion of the stud and the remainder of the stud has no diffusion coating thereon. The uncoated portion is welded to a boiler tube or furnace wall. This stud can be diffusion coated in a retort having a layer of inert material covering a first portion of the stud and a diffusion pack mix covering a second portion of the stud. When the retort is heated a diffusion coating will form on the second portion of the stud while no diffusion layer will be formed on the portion of the stud that is covered by the inert material.

### CROSS REFERENCE TO RELATED APPLICATION

This application claims priority from U.S. Provisional Patent Applications Serial No. 60/447,456 and Serial No. 60/447,538 both filed Feb. 14, 2003.

### FIELD OF INVENTION

This invention relates to studs and fins used in furnaces and boilers as anchors for refractory materials or as heat conductors.

### BACKGROUND OF THE INVENTION

Slender metal elements known as studs, fins and also as anchoring elements have been used in the industry with varied purposes. In the pulp industry, for example, they have been used in recovery boilers to dissipate heat from black liquor smelt, also know as salt cake. In this particular application the smelt solidifies and forms a plaster-like layer that prevents direct contact between the tubes and fresh incoming smelt.

Black liquor is a mixture of water, tree resins and chemicals used to accelerate the cooking process of wood chips. Upon evaporating most of the water content, black liquor becomes a quite effective fuel. When burned in special boilers, called recovery boilers, the heat content of black liquor is utilized to generate steam, which in turns generates power. The chemicals utilized in the cooking process of the wood chips melt and become an aggressive agent that promotes chemical attack of metal elements that constitute the boiler. Such action is more intensive in the lower furnace where the temperature is higher.

A very effective way to minimize or prevent such attack is to promote the rapid cooling of the smelt and bring its temperature below its melting point. By promoting such cooling the chemicals solidify and form an insulating barrier that protects the tubes and membranes which form the water walls of the boiler. The temperature along each one of these studs varies dramatically being the hottest at the stud tip which is in contact with the liquid phase of the smelt. Consequently the tips of the studs are gradually consumed and eventually will lose their capability to freeze the smelt and protect the tube.

U.S. Pat. No. 5,107,798 discloses a major improvement introduced in the art of producing these studs which consisted of protecting the surface of the fins with another material capable to withstand the chemical attack to the fins. Such protection was provided with a sleeve of stainless steel. Because stainless steel does not transfer heat as well as low carbon steel, the sleeve must be thin enough to prevent jeopardizing the heat transfer properties of the fin and must be inserted in such a manner that the expansion resulting from heating the fin would not allow the two different metals to separate from each other. This approach was very effective and was proven in the field for many years. Because the cost to manufacture the stainless steel jacketed stud was too high, a further development was introduced by the applicant. In this product chemical elements which make the material impervious to chemical attack are diffused into the base metal of the studs. A very suitable element to make the stud impervious to the chemical attack is chromium. Studs enhanced with chromium diffusion have been in use since 1995 and were proven to be very effective, increasing the life cycle of the studs by more than 100%. They are known as chromized studs. Chromized studs are designed to replace consumed parts and can also be welded on new tubes.

Crowley in U.S. Pat. No. 4,680,908 discloses refractory anchors impregnated with corrosion resistant material to minimize erosion and corrosion. Aluminum and aluminum oxide are preferred. But, he teaches that chromium, nickel, silicon, boron, zinc as well as their oxides and nitrides can be used. These materials are impregnated into the base metal by chemical diffusion. Within some limits deeper diffusion of chromium into a stud results in longer life cycle and is a desirable feature. Deeper diffusion of chromium has some negative effects on the weldability of the element and may affect negatively the metallurgical bond at the welded zone. Welding chromium coated studs to be a furnace wall may even make the material unsuitable for use in pressure parts. It is safe to say that within some limits, higher chromium diffusion enhances the life cycle of the element. But, metallurgical problems start taking place as the chromium content increases, thus limiting the amount of chromium that should be diffused into the stud.

Although diffusion coated studs and anchors have been used for many years, the art has not addressed the weld problem. Perhaps many in the industry have not recognized the problem. In any event, there is a need for a stud and refractory anchors that resist corrosion and erosion and can be securely welded to a furnace wall or boiler tube. The resulting welded structure should be suitable for use in vessels that operate at high pressure.

### SUMMARY OF THE INVENTION

I provide a method of treating studs, fins and anchors of any shape that allows a selective diffusion of chromium or other diffusion coating material into the stud and prevents diffusion at the tip which is welded to a boiler tube or furnace wall. A stud manufactured according to this invention can be significantly enhanced by chromium diffusion, or diffusion of any other element designed the enhance the stud's properties, without allowing the diffused element to be present at the tip in a quantity that would jeopardize the weld.

To make the studs in accordance with the present invention one selects a stud body of desired length made of low carbon steel or other metal alloy of the type used for conventional studs. These studs are arranged in a retort to be side-by-side and spaced apart from one another. The bottom and lower portion of the side of each stud is covered with an inert clay layer such as bentonite. The remainder of the stud is surrounded by the pack mix. The retort is then heated as in a conventional pack cementation process. During heating the chromium or other diffusion metal is deposited on that portion of each stud surrounded by the pack mix. The composition and thickness of the inert clay layer prevents the chromium or other metal from reaching the tip surrounded by the clay. Upon completion of the process most of the stud is coated with a corrosion resistant or erosion resistant material. However, there is no diffusion coating on the bottom and lower portion of the stud. The bottom end is then welded to the boiler tube or furnace wall providing a much stronger bond than could be achieved with a diffusion coated surface.

Other objects and advantages of my stud with enhanced coating and method for making same will become apparent from a description of certain present preferred embodiments thereof shown in the drawings.

### BRIEF DESCRIPTION OF THE DRAWINGS

FIG. 1 is a perspective view of my stud with enhanced coating.

FIG. 2 is a diagram illustrating a first present preferred method of making the stud.

FIG. 3 is a diagram similar to FIG. 2 illustrating a second present preferred method of making the stud.

### DESCRIPTION OF THE PREFERRED EMBODIMENTS

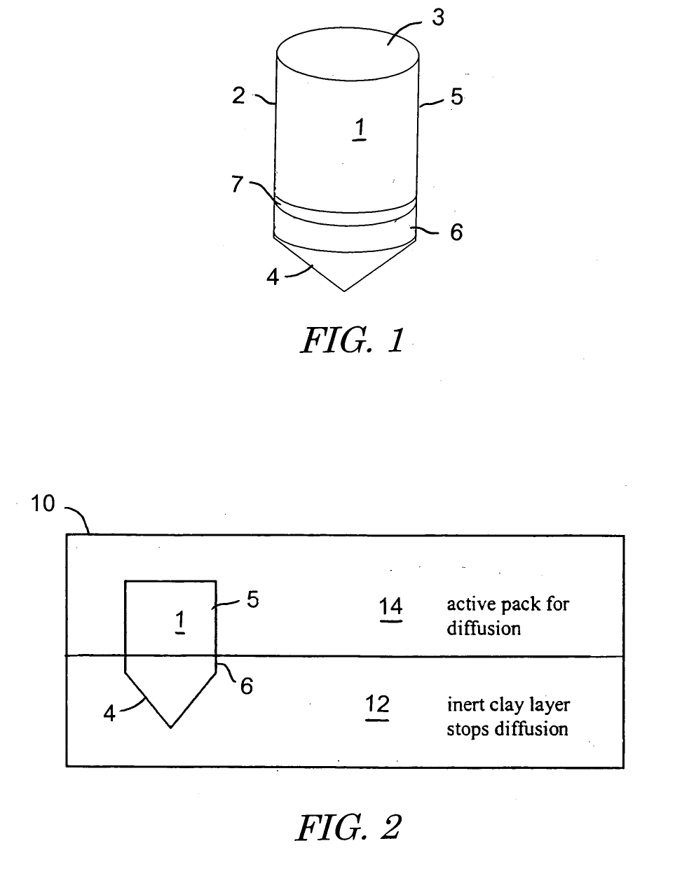

As shown in FIG. 1 a stud 1 has a generally cylindrical body 2 with a flat top 3 and a conical or frustoconical bottom 4. The top 3 and upper portion 5 of the body 2 have a diffusion coating of chromium or other corrosion resistant material. The bottom 4 and lower portion 6 of the body 2 are bare base metal. Typically the base material is low carbon steel, but any metal alloy suitable for use as a stud may be used. There may be a thinner ring 7 of chromium or other deposition material between the bare lower portion 6 and the more heavily coated upper portion 5. Portions 5 and 6 need not be smooth, but may be knurled, threaded or have a series of parallel grooves. When the stud 1 is welded to a furnace wall or boiler tube the bare bottom portion is placed on the wall or tube. Then, any suitable welding technique can be used to weld the stud to the furnace wall or boiler tube. The bare metal lower portion will form a stronger weld than would occur if a fully coated stud was used. After the weld has been made most, if not all, of the exposed surfaces of the stud will have a diffusion layer that resists corrosion and erosion. Any uncoated portions of the stud will be adjacent the surface to which the stud is welded. That region is much less likely to be struck by particles traveling through the boiler or furnace. That region is also the first portion of the stud that will be covered by a protective layer of slag when the stud is used in slag forming processes.

In FIG. 1 I have illustrated the stud as a cylinder having a flat top and a conical bottom. However, the term stud as used herein is not limited to that configuration. Rather, the term should be read broadly as encompassing any structure that is welded or attached to a furnace wall or boiler tube to transfer heat or serve as an anchor. While this process is particularly useful for studs of the type as shown in FIG. 1, it could also be used for fins and other structures in which one end or edge is to be welded and another end or edge must have a corrosion resistant or abrasion resistant coating.

A present preferred method of making the stud 1 shown in FIG. 1 is illustrated in the diagram of FIG. 2. The stud 1 is placed in a retort 10 having a layer 12 of inert clay and a layer 14 of pack diffusing material. The stud is oriented so that the bottom 4 and lower portion 6 are covered by inert clay. The upper portion 5 is surrounded by an active pack 14 of diffusion coating material. The retort 10 is closed and placed in a furnace. While in the furnace chromium or other materials diffuse onto the upper portion 5 of the stud. The clay layer 12 is inert and neither diffuses onto the stud nor allows chromium or other material from the active pack layer to diffuse onto the lower portion 6 of the stud 1. A thinner diffusion layer, identified as ring 7 in FIG. 1, may extend a short distance, typically 1 to 2 mm, below the interface of the inert clay layer and the 6. diffusion pack mix. This technique allows a more intensive diffusion of the added elements to the upper portion of the stud, thus greatly increasing the life cycle of the stud and at the same time preventing problems at the weld tip.

The clay is inert in that it does not react with the materials in or produced by the diffusion pack mix. Consequently, the choice of clay or similar material may depend upon the composition of the pack mix. Nothing in the clay should be deposited on the stud. Nevertheless, for some coating materials small amounts of diffusion coating materials may be deposited on the bottom of the stud without adversely affecting the weld. Consequently, it may not be necessary for the inert material to prevent passage of all diffusion material through the inert material. Rather, the inert material must only inhibit such passage.

In one embodiment I have used cylindrical stud bodies having a height of 23 mm. One end of the studs was covered by a layer of bentonite clay 5 to 6 mm thick. The balance of the stud was covered by a chromium pack diffusion mix. This combination was heated in an argon containing furnace sufficiently to diffuse a chromium layer on about 18 mm of the stud length that was within the pack mix. Then the studs were removed from the furnace and cooled. The clay and spent pack mix were brushed away from the studs. Except for a 1 to 2 millimeter band of thinner chromium coating adjacent the upper chromium layer, no chromium was deposited on the bottom and lower portion of the stud that were within the clay layer. Any conventional pack mix can be used. One suitable pack mix contains 42% ferrochrome as a source for chromium, 3% of ammonium chloride and the balance an inert material, preferably aluminum oxide.

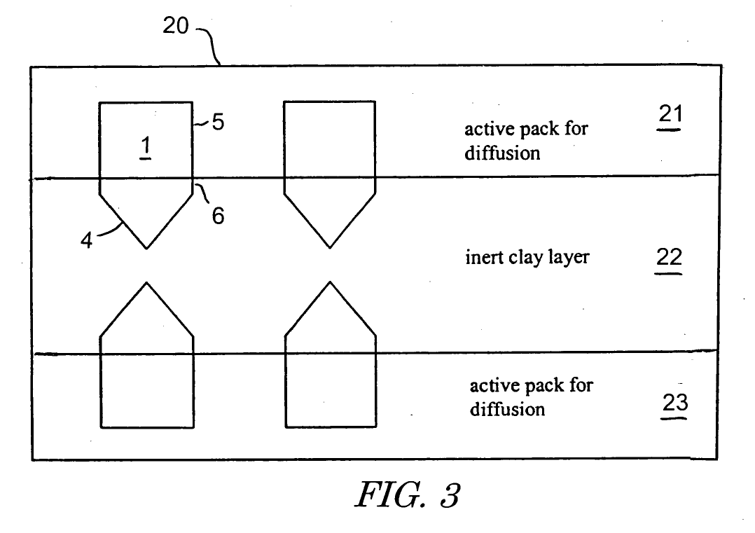

The present invention can be used to coat multiple studs simultaneously. This could be done by placing several spaced apart studs in a retort containing the layers shown in FIG. 2. Another option is to provide in a retort 20 a layer of pack mix 21, a layer of inert clay 22 and a second layer of pack mix 23 as shown in FIG. 3. The studs 1 are oriented so that the lower portion 6 of the stud is in the inert layer and the upper portion 5 is in one of the layers 21, 23 of pack mix.

While I prefer to prevent deposition of a diffusion layer on the bottom of the stud by using a layer of inert clay, those skilled in the art will recognize that other materials and arrangements can be used to mask the lower portion of the stud during disposition of the chromium or other layer. One could also use the process to create multiple regions of bare metal and of diffusion coated metal on a single part. This can be done by using multiple layers of pack mix and inert material.

In accordance with the present invention a stud can be coated with an abrasion resistant diffusion coating using any conventional diffusion process. Only those surfaces which will be subject to abrasion need to be coated. Studs, made in accordance with this invention can be welded or otherwise attached to or incorporated in tubes, panels or other structures subject to abrasion in boilers, furnaces and the like. Some of these structures are disclosed and illustrated in my U.S. Pat. No. 5,107,298.

This process could be used to apply multiple coatings or include additional steps. For example, a stud, preferably having a low carbon content such as those specified as ASTM 1010 to 1020 steel, is diffusion coated with chromium using any conventional chromium diffusion coating process. Then the coated stud is heated in an atmosphere of CO or CO₂ to form chromium carbide in the coating.

In another method the stud is diffusion coated with chromium and then boron. In yet another process boron alone is deposited on the stud. Because such a coating is very slick, few materials will stick to the surface. One could also apply a diffusion coating of rhenium to the stud. Typically, the coating will contain at least one of chromium, aluminum, nickel, silicon, boron, zinc, as well as carbides, nitrides and oxides thereof. But, other hard materials that can be applied by any conventional diffusion technique may also be used.

Although I have disclosed certain present preferred embodiments of my stud with enhanced surface and a preferred method of coating the stud it should be distinctly understood that the invention is not limited thereto but may be variously embodied within the scope of the following claims.

I claim:

1. A stud with enhanced surface comprised of an elongated body of a base metal, the body having an exterior surface comprised of a first portion and a second portion, the first portion of the exterior surface having a diffusion coating thereon and the second portion being base metal having no diffusion coating thereon.

2. The stud of claim 1 wherein the diffusion coating has a selected thickness and further comprising a third portion of the exterior surface, the third portion being between the first portion and the second portion, and a second diffusion coating on the third portion of the exterior surface, the second diffusion coating having a thickness less than the selected thickness.

3. The stud of claim 1 wherein the diffusion coating contains at least one of chromium, aluminum, nickel, silicon, boron, rhenium, zinc and carbides, nitrides and oxides thereof.

4. The stud of claim 1 wherein at least a portion of the stud body is cylindrical.

5. A method of coating a stud having a first portion and a second portion comprising:
masking the first portion of the stud;
applying a diffusion coating to the second portion of the stud; and
unmasking the second portion of the stud.

6. The method of claim 5 wherein the masking is comprised of surrounding the first portion of the stud with a layer of inert material and the diffusion coating is applied by pack deposition.

7. The method of claim 5 wherein the diffusion coating contains at least one of chromium, aluminum, nickel, silicon, boron, rhenium, zinc and carbides, nitrides and oxides thereof.

8. The method of claim 5 wherein the inert material is a clay.

9. The method of claim 5 wherein the diffusion coating contains chromium and further comprising exposing the diffusion coating to at least one of carbon monoxide and carbon dioxide in a manner to form chromium carbide in the diffusion coating.

10. A method of coating a stud comprising:
placing the stud in a retort;
covering a portion of the stud with an inert material;
covering a second portion of the stud with a diffusion pack mix;
heating the retort at a time and temperature to cause a diffusion coating to form on the second portion of the stud; and
removing the stud from the retort.

11. The method of claim 10 wherein the diffusion coating contains at least one of chromium, aluminum, nickel, silicon, boron, rhenium, zinc and carbides, nitrides and oxides thereof.

12. The method of claim 10 wherein the inert material is a clay.

13. The method of claim 10 wherein the diffusion coating contains chromium and further comprising exposing the diffusion coating to at least one of carbon monoxide and carbon dioxide in a manner to form chromium carbide in the diffusion coating.

14. The method of claim 10 also comprising exposing the diffusion coating to boron in a manner to diffuse boron into in the diffusion coating.

15. The method of claim 14 wherein the diffusion coating contains chromium.
